(19) United States
(12) Patent Application Publication
(10) Pub. No.: US 2005/0278437 A1
(43) Pub. Date: Dec. 15, 2005

(54) Network analysis software real-time

(76) Inventors: Jianhua Xie, Colorado Springs, CO (US); Canning Hsueh, Colorado Springs, CO (US)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/852,225

(22) Filed: May 25, 2004

(51) Int. Cl. G06F 15/173

(52) U.S. Cl. 709/223

(57) ABSTRACT

A method and system of enabling real-time network protocol analysis of network data by a post-time network protocol analyzing software that is incompatible with a real-time protocol analyzing software real-time capturing network data, by controlling the real-time protocol analyzing software and taking over a communication socket opened by the real-time protocol analyzing software, thereby transparently porting the post-time network protocol analyzing software to the real-time protocol analyzing software. Further, a method and system of enabling the post-time network data analyzer software to analyze network data captured concurrently in real-time from two or more of the real-time protocol analyzing software based upon time stamping by the real-time protocol analyzing software of every data frame received over the taken-over sockets.

### BACKGROUND OF THE INVENTION

1. Description of the Related Art

FIG. 1 is a diagram of an example network including a post-time network analysis software (NAS) (or network protocol analysis/analyzer software/application) that analyzes in a post-time fashion network data captured by real-time network data capturing equipments. In a network test environment, network data capturing equipments 100 (100a-n) are communicably connected to network(s) 102 under test (test networks 102) to capture the network data in real-time. The test networks 102 can be any type of network, such as an Asynchronous Transfer Mode (ATM) network, a 3G wireless mobile communications network, a TCP/IP network, etc. Network analyzers that are software implemented on personal computers (NA PC SW) 104 (104a-n) receive, analyze, and store the real-time network data captured by the network data capturing equipments 100a-n. More particularly, the NA PC SW 104 interface with the network data capturing equipments 100a-n through an NA PC SW interface 103 (103a-n).

If another or new network analyzer software (analyzer application) is implemented (for example by another entity or development team), or becomes available, to analyze captured network data, such as the (NAS) 106 application, but is incompatible with the NA PC SW 104 and/or does not include the NA PC SW interface 103 to interface with network data capturing equipments 100a-n, the NAS 106 cannot control (interface with) the network data capturing equipments 100a-n to capture real-time network data to provide network data analysis functions (i.e., measurements) of the NAS 106. Therefore, to provide/use/market the network data analysis functions (i.e., measurements) of the NAS 106, which is incompatible with the NA PC SW 104 and/or the network data capturing equipments 100, conventionally there have been two options of performing post-time network data analysis functions (i.e., post-time measurements), or transplanting the incompatible NAS 106 network data analysis functions to the NA PC SW 104.

Regarding post-time measurements, the real-time captured network data can be stored by the NA PC SW 104 in created files 108a-n and accessed by the NAS 106 in a post-time fashion to perform post-time analysis of the stored network data. However, for example, post-time network data analysis can be inefficient by troubleshooting outdated network data and lead to erroneous or unreliable troubleshoot results versus real-time network data analysis and troubleshooting. Regarding measurement transplantation, because the NAS 106 is likely to be very different from the NA PC SW 104 and the NA PC SW interface 103, software transplanting or porting will entail great efforts and will take a long time. For example, the NA PC SW 104 user interface (UI) and data handling classes can be derived from a rich set of platform base classes, such that to make the NAS 106 user interface classes and data handling classes work with the NA PC SW 104 UI and data handling classes takes a lot of effort (i.e., most of the NAS 106 code has to be re-written). Further, the NA PC SW interface 103 to the network data capturing equipments 100 is likely to be based upon a specific (less standard) interface format, requiring writing of new specific complicated program code in the NAS 106 to directly communicably connect with the network data capturing equipments 100 via the NA PC SW interface 103. Accordingly, long software porting increases research and development cost and significantly delays time-to-market of new measurements.

Also, as shown in FIG. 1, one instance of the NA PC Software 104 controls only one network data capturing equipment 100. And each network data capturing equipment 100a-n provides network data for a network analyzer software (e.g., NA PC SW 104, NAS 106, etc.) measurement by capturing real-time data and sending the captured real-time network data through a dedicated communication socket 105 (105a-n) to the NA PC SW 104a-n to be analyzed, or stored and analyzed in case of the NAS 106. The NAS 106, the files 108a-n, the NA PC SW 104 and the network data capturing equipments 100 are typically communicably connected on Internet Protocol (IP)/dedicated networks 110.

### BRIEF DESCRIPTION OF THE DRAWINGS

The described embodiments herein will become more apparent and more readily appreciated in conjunction with the accompanying drawings of which:

FIG. 1 is a diagram of an example network including a network analysis software (NAS) analyzing in a post-time fashion network data captured by real-time network data capturing equipment.

FIG. 2 is a diagram of a network including a network analysis software real-time (NAS RT) analyzing in a real-time fashion network data captured in real-time by network data capturing equipments, according to an example embodiment.

FIG. 3 is a flow chart of network analysis software real-time (NAS RT) interfacing with the real-time store to media (RTSM) acquisition systems, according to an example embodiment.

FIG. 4 is a diagram of an example wireless mobile network analyzed by the SART shown in FIG. 2, according to an example embodiment.

FIG. 5 is a diagram of an example Asynchronous Transfer Mode (ATM) network analyzed by the SART shown in FIG. 2, according to an example embodiment.

### DETAILED DESCRIPTION OF THE EMBODIMENTS

Reference will now be made in detail to described embodiments, examples of which are illustrated in the accompanying drawings, wherein like reference numerals refer to the like elements throughout. The embodiments are described below by referring to the figures.

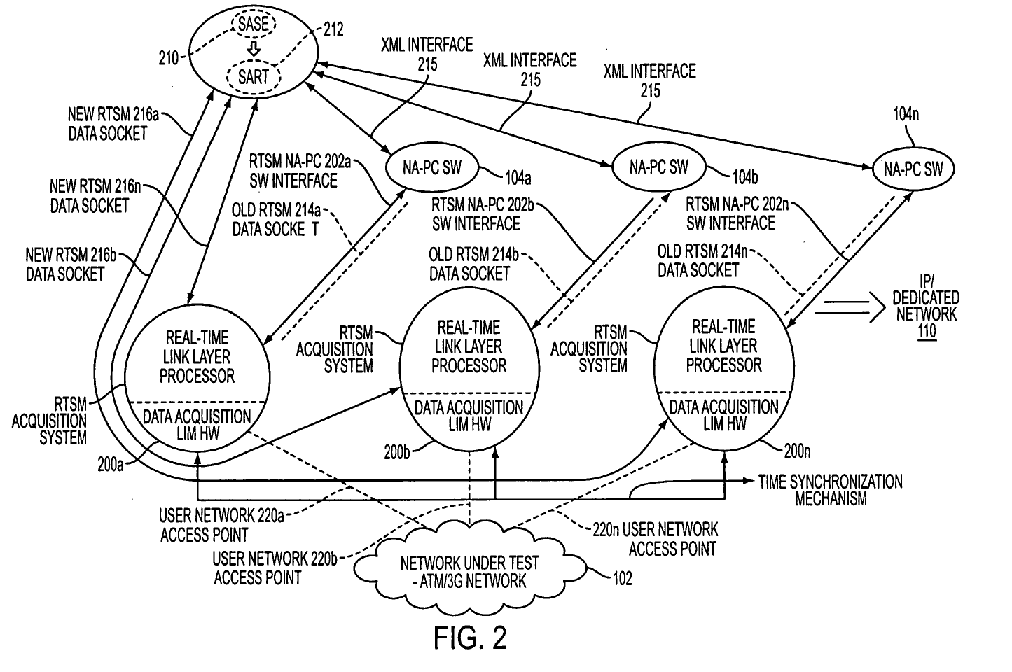

FIG. 2 is a diagram of a network including a network analysis software real-time analyzing in a real-time fashion network data captured in real-time by network data capturing equipments, according to an example embodiment. In FIG. 2, for example, the network analysis software, which analyzes network protocols in real-time, can be SIGNALING ADVISOR Real-time (SART) available from AGILENT TECHNOLOGIES, INC., Palo Alto, Calif., assignee of the present application. In FIG. 2, as an example of a network test environment in which the embodiments described herein can be implemented, network data capturing equipments are implemented according to Real-time Store To Media (RTSM) Acquisition Systems 200 (200a-n) (hereinafter referred to as (RTSM) available from AGILENT TECHNOLOGIES, INC., Palo Alto, Calif., assignee of the present patent application. For example, the RTSM 200 comprises the AGILENT Real-time Link Layer Processor (LLP) Hardware System portion and the Data Acquisition Line Interface Module (LIM) Hardware (DA LIM HW) portion. The Real-time LLP Hardware System portion of the RTSM 200 is a computer under control of the VxWork operating system (although any type of operating system can be used), and the DA LIM HW is communicably connectable to the networks under test 102.

The DA LIM HW of the RTSM 200 has a plurality of interfaces, each interface to a different kind of network 102 being tested (test network 102) for real-time capturing network data, such as dedicated phone connections, mobile communications, fiber-optic transmission systems, and packet or cell network technologies. For example, when using the Open System Interconnection (OSI) network layers as a reference, the DA LIM HW can comprise one DA LIM HW interface for layer 2 dedicated phone connection line of T-I/DS1/E1, one DA LIM HW interface for layer 2 dedicated phone connection line of T-3/DS3/E3, one DA LIM HW interface for layer 2 fiber-optic transmission system of Synchronous Optical Network (SONET) (e.g., Optical Carrier levels 3, 12), one DA LIM HW interface for layer 2 mobile communications of 3G wireless mobile communications network, one DA LIM HW interface for layer 2 packet or cell network technology of Asynchronous Transfer Mode (ATM), a V series LIM, or etc. Further, test networks 102 can use any type of upper layer network technology, such as wireless mobile communications network technologies, TCP/IP, etc. The embodiment can be applied to capturing and analyzing other OSI network layers. Therefore, the RTSMs 200 are communicably connectable to the test network(s) 102 to capture the network data in real-time.

In FIG. 2, the network analyzers that are software implemented on personal computers (NA PC SW) 104 receive, analyze, and store the real-time network data captured by the RTSMs 200. More particularly, one NA PC SW 104a-n interfaces with each RTSM 200a-n through an RTSM NA PC SW interface 202a-n, such that a single instance of the NA PC SW 104 controls only one RTSM 200. Generally, a “measurement” refers to analysis of one or more network-related variables, such as network data, by a network analyzer software application, such as the NA PC SW 104.

In FIG. 2, if another or new network analyzer software (analyzer application) is implemented (for example by another entity or development team), or becomes available, to analyze captured network data, such as SIGNALING ADVISOR Software Edition (SASE) 210 available from AGILENT TECHNOLOGIES, INC., Palo Alto, Calif., assignee of the present patent application, but SASE 210 is incompatible with the NA PC SW 104 and/or does not include the RTSM NA PC SW interface 202 to interface with the RTSM acquisition systems 200, the SASE 210 cannot control (interface with) the RTSM acquisition systems 200 to capture real-time network data to provide any real-time measurements. In other words, conventionally, the SASE 210 reads and analyzes network data files created by the NA PC SW 104 in a post-time fashion.

More particularly, using SASE 210 as an example of a second network analyzer software application to be incorporated or ported (interface, integrated or blended with) to the NA PC SW 104 as a first network analyzer software application, the SASE 210 and the NA PC SW 104 are two totally separate applications running on two entirely different platforms. In this example, when the SASE's real-time acquisition system portion became obsolete, a large portion of SASE's measurement portion was modified to become a separate MICROSOFT WINDOWS application to meet the demands from 3G wireless mobile communications network customers or network data analyzer (NA) measurement users (hereinafter referred to as customers, such as 3G customers).

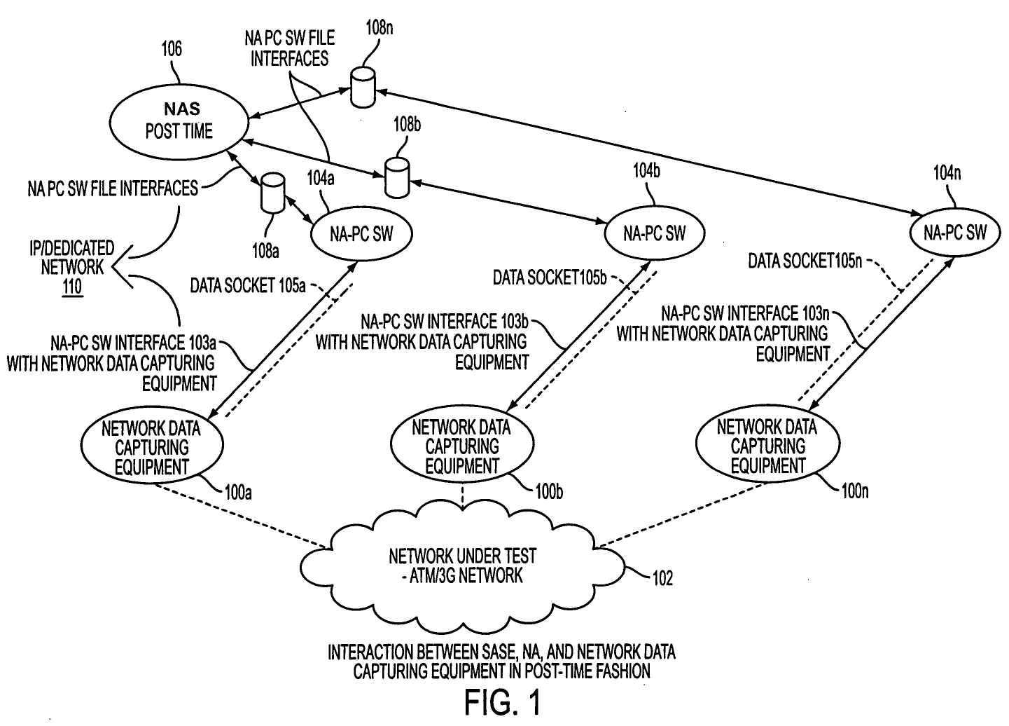

However, because the SASE 210 and NA PC SW 104 are very different, porting SASE 210 to the NA PC SW 104 will entail great efforts and will take a long time. For example, the NA PC SW 104 user interface and data handling classes could be derived from a rich set of different and/or proprietary (as the case may be) platform base classes, and to make SASE 210 user interface classes and data handling classes work with the NA PC SW 104 platform classes would take a lot effort, such that essentially most of the SASE 210 software code has to be re-written. Also, significantly, the RTSM NA PC SW interface 202 to the RTSM acquisition system 200 is based upon many configuration and/or control messages that are very complicated in format, which the SASE 210 cannot process, effectively requiring writing of new specific (less standard) complicated program code in the SASE 210 to directly communicably connect with the RTSM acquisition system 200 concerning such configuration and/or control messages. In particular, the NA PC SW 104 and the RTSM acquisition system 200 may have been developed as one distributed application and considered one system; such that the RTSM NA PC SW interface 202 is not necessarily a standalone, independent, standard interface between the NA PC SW 104 and the RTSM acquisition system 200, making portability difficult. Further, such portability difficulty would exist even if the both first and second network analyzing software are implemented in same operating system, as is the case with SASE 210 and the NA PC SW 104 both implemented based upon the MICROSOFT WINDOWS operating system platform. As a result, as shown in FIG. 1 regarding the NAS 106, the SASE 210 read and analyzed network data files created by the NA PC SE 104 in a post-time fashion. However, SASE 210 should also capture and analyze network data in real-time.

According to the embodiment described herein and as shown in FIG. 2, to minimize investment and to take a time-to-market approach, the NA PC SW 104 was slightly modified to interface with the SASE 210. In other words, both the SASE 210 and NA PC SW 104 were modified to communicate messages with each other based upon an interface designed according to a standard specification (a standard communication technique), such as a markup language based messaging (data communication) interface. In particular, for example, a markup language according to the Standard Generalized Markup Language (SGML) rules, such as (without limitation) Extensible Markup Language (XML), is used to transmit and receive messages between the SASE 210 and the NA PC SW 104. In the example embodiment, the SASE 210 interfaces with the NA PC SW 104 according to XML interface 215. Although the embodiment described herein is not limited to such a configuration, and other standard data communication technologies/specifications, such as FTP, can be used between SASE 210 and the NA PC SW 104. The XML interface 215 can be understood by referring to patent application titled “EXTENSIBLE NETWORK AGENT METHOD, SYSTEM, AND ARCHITECTURE”, inventors Merlin A. Rhoda, et al., Attorney Docket PD No. 10030966-1, U.S. application Ser. No. 10/697,270, filed Oct. 31, 2003, which is incorporated herein by reference.

In FIG. 2, the RTSM acquisition system 200 can provide network data for a network analyzer software (e.g., NA PC SW 104, SASE 210, etc.) measurement by capturing real-time data from the test network 102 and sending the captured real-time network data through a dedicated RTSM data socket to the NA PC SW 104 to be analyzed, or stored by the NA PC SW 104 and then analyzed in case of the SASE 210. According to the embodiment described herein, to provide SASE 210 real time measurements, instead of combining the SASE 210 and the NA PC SW 104 (i.e., instead of software transplantation of one network analyzer software to another network analyzer software), the SASE 210 launches the NA PC SW 104, and then the SASE 210 takes control of the dedicated RTSM socket to the NA PC SW 104 and routes RTSM data directly to the SASE 210 via the same RTSM socket now in communication with the SASE 210. In this way, the SASE 210 becomes the SIGNALING ADVISOR Real-time (SART) 212, available from AGILENT TECHNOLOGIES, INC., Palo Alto, Calif., assignee of the present application, providing real-time measurements by indirectly (as described in more detail further below) controlling capture and analysis of real-time data, for example, for 3G customers. This real-time version of SASE 210 becomes SART 212 (Real-time SASE). More particularly, as described in more detail further below, SASE 210 becomes the SART 212 by controlling tearing down an old RTSM data socket 214 (214a-n) between the RTSM 200 and the NA PC SW 104 and establishing a new data socket 216 (216a-n) between the RTSM 200 and the SASE 210, thereby the SASE 210 taking over an active RTSM 200 data communication socket 216 with simple socket taking over mechanisms (function extensions) included in the SASE 210, the NA PC SW 104 and the RTSM 200.

In FIG. 2, the SART 212 also enables concurrently analyzing real-time network data captured from two or more RTSM 200a-n in one network analyzer software, which differs from the FIG. 1 network test configuration in which one instance of NA PC SW 104a-n received network data from one network data capturing equipment 100a-n without correlating the network data received from multiple network data capturing equipments 100. More particularly, each RTSM 200a-n is provided with a function extension of time stamping every real-time network data frame captured by each RTSM 200a-n, so that SART 212 can now receive and analyze real-time network data from multiple instances of RTSM 200, with all the data streams time-synchronized in a real-time fashion. The SART 212 rearranges the real-time network data frames received from the multiple RTSM 200a-n via the activated new RTSM data sockets 216 in time order by comparing the timestamp carried by each data frame. This multi-port solution allows providing an important feature to customers, especially the 3G customers, because, for example, within one decode view as a 3G measurement, a customer can be presented with real-time network data from different network access points 220 (220a-n) in which the frames/cells from the different network access points are time-ordered.

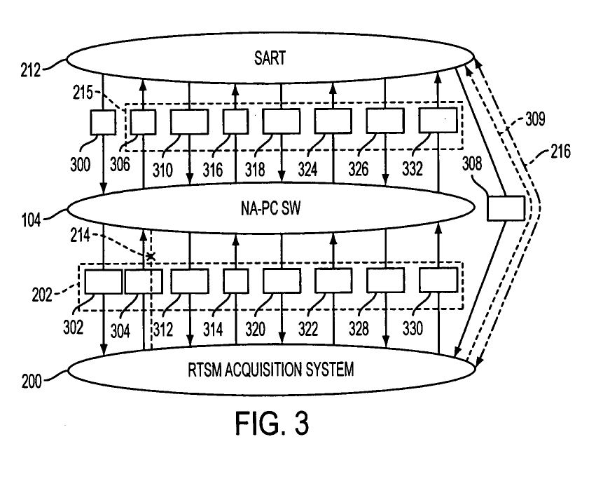

FIG. 3 is a flow chart of SART interfacing with the real-time store to media (RTSM) acquisition systems, according to an example embodiment. According to an aspect of the described embodiment, the SART 212 and the NA-PC SW 104 can run on one computer or in separate communicably connected computers. In FIG. 3, at operation 300, the SART 212 launches an instance or one (single) NA PC SW application 104. If the SART 212 and the one NA-PC SW 104 run on one computer, the SART 212 can typically launch the one NA PC SW application 104 via services provides by an operating system of the computer. At operation 302, the one NA PC SW 104 gets launched and tries to connect via a launch connection request to one of the RTSM acquisition systems 200a-n. At operation 304, the one RTSM 200 responds to the one NA PC SW 104, if the launch connection request is accepted. Further, at this time in operation 304, an RTSM data socket 214 (see also FIG. 2) is established between the one NA PC SW 104 and the one RTSM 200 (i.e., an open line data communication connection pipe 214 is established between the NA PC SW 104 and the RTSM 200, in response to the connection request from the NA PC SW 104 to the RTSM 200). According to an aspect of the described embodiment, there can be multiple instances of RTSM 200a-n, and in case of multiple RTSM 200a-n, the SART 212 launches multiple instances the NA-PC SW 104 with each launched RTMS 200a-n instance connecting to each RTSM 200a-n one-by-one. The number of RTSMs 200a-n to connect to is configurable based upon measurement requirements/design. At operation 306, the NA PC SW 104 responds to the SART 212 that the one instance of the NA PC SW 104 has been launched successfully. In particular, the NA PC SW 104 can typically launch successfully, if it can establish the RTSM data socket 214 with the one RTSM 200, otherwise, the NA PC SW 104 cannot launch successfully.

After, in operation 306, a successful launch of the one instance of NA PC SW 104, at operation 308, the SART 212 bypasses the NA PC SW 104 and directly sends a take-over socket request to the one RTSM acquisition system 200 to take over the established old RTSM data socket 214 between the one NA PC SW 104 and the one RTSM 200. More particularly, if, at operation 308, the one RTSM 200 accepts the take-over socket request from the SART 212, the old RTSM data socket 214 between the one RTSM 200 and the one NA PC SW 104 is torn down and a new RTSM data socket 216 is established between the one RTSM 200 and the SART 212. Therefore, at operation 308, the socket takeover of a network data capturing equipment (e.g., 100, 200, etc.) actually typically comprises two operations, first, in response to a take-over socket request from a requestor network analyzer software (which is a target or a second network analyzer software, such as the SART 212), the network data capturing equipment tears down (e.g., closes) the already established/secured/opened data socket 214 between the network data capturing equipment and an original or first network analyzer software, such as the NA PC SW 104, and second, at operation 309, the network data capturing equipment establishes a new data docket 216 between the network data capturing equipment and the requestor network analyzer software, which in this example is the SART 212.

The RTSM 200 can typically determine which old RTSM data socket 214 with the NA PC SW 104 to tear down and to re-establish/activate the new RTSM data socket 216 with the SART 212, because each RTSM 200a-n has only one data socket concerning real-time data from the test network(s) 102 at a user (customer) network access point 220a-n. Further, the SART 212 knows the address of the one RTSM 200, for example, an IP address of the RTSM 200 in case the RTSM 200 is accessible on an IP network 110, to directly send the take-over socket request to the RTSM 200. More particularly, for example, when, at operation 308, the SART 212 takes over the old RTSM data socket 214, the SART 212 sends a take-over socket request over the IP/Dedicated network 110 to the RTSM 200 by knowing the IP address of the RTSM 200 and the SART 212 also contains (includes) SART's 212 own IP address in the take-over socket request. So when, at operation 308, the RTSM 200 receives the take-over socket request from the SART 212, at operation 309, the RTSM 200 knows to whom (to what) the RTSM 200 should establish a new RTSM data socket 216 and provide acknowledgment. Therefore, a network data capturing equipment, such as the RTSM 200, only needs addition of a simple function extension to accept and process a take-over socket request from a second software analyzer, such as the SART 212, to open a new network data socket connection path between the second software analyzer (e.g., SART 212) and the network data capturing equipment (e.g., RTSM 200). Once SART 212 configures the one RTSM 200 through the NA PC SW 104 and takes over the new RTSM data socket 216, network data is only sent to the SART 212 and the NA PC SW 104 no longer receives the network data. Although, the SART 212 still controls configuration and/or operation control of the RTSM 200 through the NA PC SW 104 and the RTSM NA PC SW interface 202 concerning the real-time capturing and transmission of the network data by the RTSM 200 to the SART 212 over the new RTSM data socket 216.

Once at operations 308 and 309 the new RTSM data socket 216 is established between the SART 212 and the one RTSM 200, operations 310 through 332 provide an example of the XML interface 215 configuration and/or control messages and the RTSM NA PC SW interface 202 configuration and/or control messages among the SART 212, the NA PC SW 104 and the RTSM 200 to use a first real-time network analyzer software (e.g., NA PC SW 104) to provide a real-time measurement at a second network analyzer software (e.g., SART 212) by controlling a network data capturing equipment (e.g., RTSM 200) through the first network analyzer software (e.g., NA PC SW 104). In particular, such configuration and control information is first sent to the NA PC SW 104 via the XML interface 215, which in turn is delivered by the NA PC SW 104 to the RTSM 200 in exactly same way as when the NA PC SW 104 typically communicates with the RTSM 200.

As described above with reference to FIG. 2, the SART 212 and the NA PC SW 104 communicate configuration and/or control messages with each other based upon the XML format interface 215. More particularly, according to the described embodiment, a requestor network analyzer software (which is a target or a second network analyzer software, such as the e.g., SART 212), interfaces (e.g., configures, controls, etc.) an original or a first network analyzer software, such as the NA PC SW 104 via a new established interface protocol, such as the XML interface 215, which can typically be at a higher level of abstraction (i.e., simplified) than an established interface between the first network analyzer software and the network data capturing equipment, such as the NA-PC SW interface 103 or the RTSM NA PC SW interface 202. For example, in the case of RTSM NA PC SW interface 202, configuration and/or control messages to interface the NA PC SW 104 with the RTSM 200 are numerous and in a very complicated or non-standard format, such that it is undesirable and not-practical, by requiring substantial rewriting or writing of new specific complicated program code in the SASE 210, to attempt to directly communicably connect concerning configuration and/or operational control the SASE 210 with the RTSM 200 via the RTSM NA PC SW interface 202. Therefore, the SASE 210 and the RTSM 200 are only added with simple function extensions to directly send and process, respectively, the take-over socket request command, so that real-time network data captured by the RTSM 200 can be routed directly to the SART 212, although configuration and/or operational control relating to the real-time network data capturing is still controlled by the SART 212 through the NA PC SW 104 and the RTSM NA PC SW interface 202.

Therefore, the described embodiment uses an interface based upon a standard specification, which in the present example is an XML based interface at the SART 212 to encapsulate an abstracted RTSM 200 configuration and/or control related message that can be processed by the NA PC SW 104 and to send the encapsulated message to the NA PC SW 104. The NA PC SW 104 translates such received XML configuration and/or control related interface 215 message into a format that the RTSM 200 can process (i.e., translate a received XML message into the RTSM NA PC SW interface 202 format message). This way, the NA PC SW 104 only interprets XML configuration and/or control related interface 215 messages received from the SART 212 and translates the XML interface 215 messages into the RTSM NA PC SW interface 202 messages that the RTSM 200 can process (understand), which is much easier. Further, the NA PC SW 104 interprets RTSM NA PC SW interface 202 messages received from the RTSM 200 and translates the received messages into XML configuration and/or control related interface 215 messages that the SART 212 can process.

Referring to FIG. 3, at operations 310 through 316 configuration information (typically a series of configuration messages) is sent to the NA PC SW 104 via the XML interface 215, which in turn is delivered by the NA PC SW 104 to the RTSM 200 via the RTSM NA PC SW interface 202 in exactly same way as when the NA PC SW 104 normally (without modification) communicates with the RTSM 200. For example, at operation 310, the SART 212 sends an XML interface 215 configuration message to the NA PC SW 104. At operation 312 the NA PC SW 104 translates the XML interface 215 configuration message received from the SART 212 to an RTSM NA PC SW interface 202 configuration message and forwards the translated configuration message to the one RTSM 200. At operation 314, the RTSM 200 acknowledges to the NA PC SW 104, if the RTSM 200 was properly configured in response to the configuration message received from the SART 212 through the NA PC SW 104. At operation 316, the NA PC SW 104 uses an XML interface 215 acknowledgment message to forward to the SART 212 the properly configured acknowledgment received from the RTSM 200.

An example XML interface 215 configuration message sent at operation 310 from the SART 212 to the NA PC SW 104 is as follows. This example XML interface 215 configuration message, first commands deletion of all the original channels and sets up a new channel in the network data acquisition system, such as the RTSM 200.

<NTML>
<channelConfig>
<clearAllChannels/>
<createChannel name=”link1”portNumber=”1”channelNumber=”1”

framing=”HDLC_BASIC” filtering=”enable”hdlcCrc=””>
<timeslot number=”1” bitmask=”ff”/>
</createChannel>
</channelConfig>
</NTML>

More particularly, the operation of the XML interface 215 is to configure the network data acquisition system according to the user (customer) specification. Once at operations 310 through 316, the one RTSM 200 is configured, real-time network data capture can be started. For example, at operation 318, the SART 212 sends an XML interface 215 start run request message (start capture network data message) to the NA PC SW 104. At operation 320 the NA PC SW 104 translates the XML interface 215 start capture network data message received from the SART 212 to an RTSM NA PC SW interface 202 start capture network data message and forwards the translated start capture network data message to the one RTSM 200. At operation 322, the RTSM 200 acknowledges to the NA PC SW 104, if the RTSM 200 starts capturing network data in response to the start capture network data message received from the SART 212 through the NA PC SW 104. At operation 324, the NA PC SW 104 uses an XML interface 215 acknowledgment message to forward to the SART 212 the start capture network data acknowledgment received from the RTSM 200. Once at operation 322 network data capturing (i.e., a run) is started, at operation 322, the RTSM 200 sends real-time captured network data to the SART 212 via the new RTSM data socket 216 in exactly same way as when the RTSM 200 sends data the NA PC SW 104. Therefore, at operation 322, the real-time network data from the test network(s) 102 is received by the second network analyzer software (e.g., SART 212) on the PC side through the newly activated (taken-over) data socket 216 at operations 308 and 309 between the second network analyzer software (SART 212) and the network data capturing equipment (e.g., RTSM 200).

More particularly, once the second network analyzer software (e.g., SART 212) receives real-time network data from the network data capturing equipment (e.g., the one RTSM 200) via the new taken-over data socket 216 between the second network analyzer software and the network data capturing equipment, the second network analyzer software can provide real-time measurements without substantial program code modifications to interface with the network data capturing equipment (or at least in the case of SASE 210 without modifying the SASE 210 to directly interface with the RTSM 200 concerning configuration and/or control of the RTSM 200), because network data capturing equipment configuration and/or control is transparently performed through the first network analyzer software (e.g., through the NA PC SW 104).

At operation 326, the SART 212 sends an XML interface 215 stop run request message (stop capture network data message) to the NA PC SW 104. At operation 328 the NA PC SW 104 translates the XML interface 215 stop capture network data message received from the SART 212 to an RTSM NA PC SW interface 202 stop capture network data message and forwards the translated stop capture network data message to the one RTSM 200. At operation 330, the RTSM 200 stops capturing the network data and acknowledges the same to the NA PC SW 104, in response to the stop capture network data message received from the SART 212 through the NA PC SW 104. Therefore, at operation 330, the SART 212 stops receiving real-time network data from the RTSM 200. At operation 332, the NA PC SW 104 uses an XML interface 215 acknowledgment message to forward to the SART 212 the stop capture network data acknowledgment received from the RTSM 200.

According to an aspect of the described embodiment, the new taken-over data socket 216 is not torn down (disconnected) at operation 330, but typically the new taken-over data socket 216 is torn when the SART 212 is exited. In other words, the SART 212 can start and stop real-time measurements as desired, because the new taken-over data socket 216 is still active. The above-described operations 310 through 330 are only one example configuration/control message flow among a first network analyzer software (e.g., NA PC SW 104), a second network analyzer software (e.g., SART 212) and one network data capturing equipment, and the described embodiment is not limited to such a message flow, and other already provided/established interface messages (e.g., RTSM NA PC SW interface 202 messages) between the first network analyzer software (e.g., NA PC SW 104) and the network data capturing equipments (e.g., RTSM 200) can be used (or newly developed as the case may be) to accommodate various types of circumstances, such as (without limitation) error handling, etc.

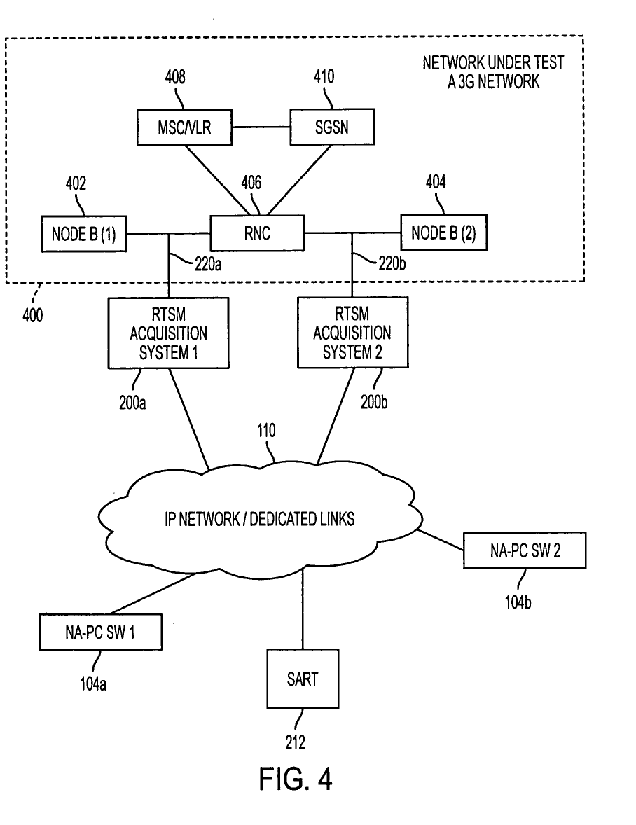

FIG. 4 is a diagram of an example wireless mobile network analyzed by the SART shown in FIG. 2, according to an example embodiment. In FIG. 4, an example of 3G wireless mobile communications network 400, as a test network 102, comprises standard 3G network components of Nodes B(1), B(2) 402, 404, a Radio Network Controller (RNC) 406, a Mobile Switching Center/Visiting Location Register (MSC/VLR) 408, and a Serving Global Packet Radio Service (GPRS) Support Node (SGSN) 410, all communicably connected. The 3G network 400 is an example of a customer network under test (test network 102). Two RTSMs 200a-b can be provided between the Node B(1) 402 and the RNC 406, and between the RNC 406 and the Node B(2) 404, as user (customer) network access points 220a-b. Real-time network data is captured at the user network access points 220a-b and transmitted, via an IP network/dedicated links 110 over taken-over data sockets 106a-n, to the SART 212, while the two RTSMs 200a-b are controlled by the SART 212 concerning configuration and/or control of the captured real-time network data through the respective NA PC SWs 104a-b of the RTSMs 200a-b, according to the above-described embodiment with reference to FIGS. 2 and 3.

Therefore, with reference to FIGS. 2, 3 and 4, if the NA PC SW 104a-b as first network analyzer software cannot provide 3G measurements or provide certain 3G related measurements, and the SASE 210 as a new second network analyzer software can provide such 3G measurements, but only in a post-time fashion (i.e., not real-time) because of incompatibility with existing network data capturing equipments, such as the RTSMs 200a-b, through the above-described take-over data socket and routing technique, the post-time SASE 210 as the second network analyzer software can be transformed into a real-time second network analyzer software, such as the SART 212. For example, if the SASE 210 has been written for a 3G network 400 to provide certain 3G real-time measurements, but its real-time network data capturing equipment becomes obsolete, the SASE 210 can be efficiently interfaced with another existing or new real-time network data capturing equipment through a network analyzer software of the existing or new real-time network data capturing equipment to provide the certain real-time 3G measurements that are not provided by the network analyzer software of the existing or the new real-time network data capturing equipment. Such new certain real-time 3G measurements can be, for example, call trace and decoding measurements (i.e., the SASE 210 is transparently transformed into SART 210 to provide new 3G real-time measurements not provided by the NA PC SW 104).

Advantageously, the take-over data socket technique minimizes investment and takes a time-to-market approach, by requiring only slight modification to the network data capturing equipment and its associated first network analyzer software to interface in a real-time fashion with a second network analyzer software (e.g., write some simple extensions, such as a simple XML interface 215 and a program function in the RTSM 200 to handle a take-over socket request command from the second analyzer software). The embodiment described herein, allows any protocol analyzing applications to run together by sharing the same real-time data captured from line, without any effort to port one application over another. With some simple extensions, it can also enable multiple network analyzer software applications to share the same real-time data source, or to share from a pool of real-time data source.

Next, with reference to FIG. 4, time synchronization will be described. In FIG. 4, there are multiple instances of the RTSM 200 (in this example two RTSMs 200a-b), and corresponding multiple instances of the NA PC SW 104 (in this example two NA PC SW 104a-b corresponding to the two RTSMs 200a-b). In FIG. 4, a process is provided enabling one network protocol analysis software (e.g., SART 212) to receive and analyze network data captured by two or more data capturing equipments (e.g., RTSM acquisition systems 200a-b) by time stamping every data frame captured by the network data capturing equipments. A handshake or other mechanism can be used among the network data capturing equipments to synchronize their time (clocks) for proper time stamps by each network data capturing equipment. The network protocol analysis software (e.g., SART 212) rearranges the data frames received from multiple data acquisition systems (e.g., RTSMs 200a-b) via respective (corresponding) activated taken-over data sockets 216a-b between the SART 212 and each RTSM 200a-b in time order by comparing the timestamp carried by each data frame. The embodiment described herein, allows data collected from multiple networks (i.e., multiple network data capturing equipments 200a-n at multiple network access points 220a-n) to be analyzed by a centralized real-time multi-port piece of network analyzer software (e.g. SART 212). When the captured real-time network data are time-synchronized, the centralized real-time multi-port network analyzer software, such as the SART 212, can time-order and correlate the data and present real-time measurements to the user (customer) in a centralized view. Other new useful applications can also be implemented as required by the customer. For example, delay of a packet before and after it enters a piece of customer equipment can be measured. Another application can be to measure the number of packets lost before and after they enter a section of a network.

In FIG. 4, in contrast, before the SART 212, one instance of the NA PC SW 104a-b controlled only one network data capturing equipment, such as the RTSMs 200a-b, so a centralized real-time multi-port network analyzer software could not be provided (i.e., not at least without substantial program code writing to correlate real-time data captured by each NA PC SW 104a-b). Therefore, another important addition to SART 212 is that time stamps are also implemented, so that SART 212 can now receive real-time network data from multiple instances of RTSM 200 through taking over multiple data sockets 106a-n to the RTSMs 200a-n, with all the network data streams time-synchronized in a real-time fashion. Such multi-port solutions allow providing, from a customer perspective, especially a 3-G customer, as a measurement, wireless call messages (e.g., frames, packets, messages) that can be traced by being displayed and analyzed sequentially based upon time order of the transmitted call messages to determine lost/misplaced messages, etc.

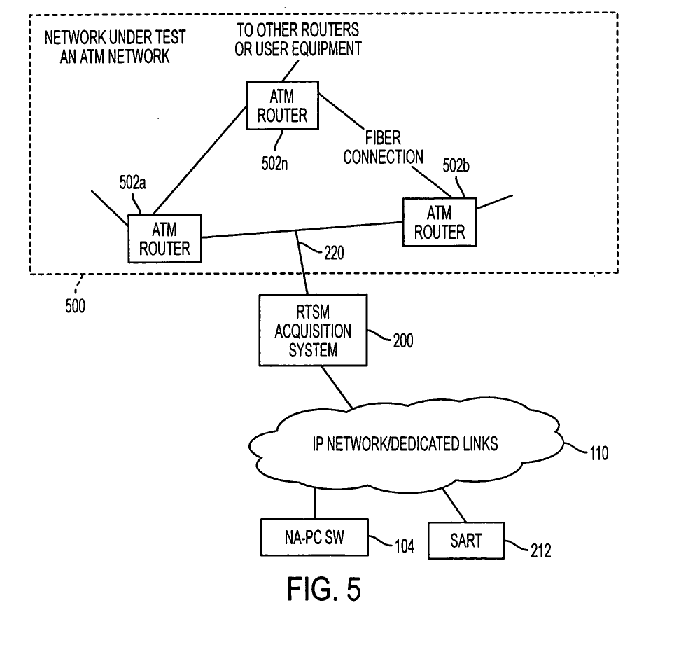

FIG. 5 is a diagram of an example Asynchronous Transfer Mode (ATM) network analyzed by the SART shown in FIG. 2, according to an example embodiment. In FIG. 5, an example of ATM network 500 using fiber connections, as a test network 102, comprises three ATM routers 502a-n (502). The ATM network 500 is an example of a customer network under test (test network 102). The RTSM 200 can be provided between two of the ATM routers 502a and 502b, as a user (customer) network access point 220a, to capture real-time network data therebetween at the user network access point 220a and transmit the captured real-time network data via an IP network/dedicated link 110 to the NA PC SW 104 and the SART 212 according to the above-described embodiment with reference to FIGS. 2 and 3.

Therefore, with reference to FIGS. 2, 3 and 5, if the NA PC SW 104 as a first network analyzer software cannot provide ATM measurements or provide certain ATM related measurements (as the case may be), but the SASE 210 as a new second network analyzer software can provide such ATM measurements only in a post-time fashion (i.e., not real-time) because of incompatibility with existing network data capturing equipments, such as the RTSM 200, through the above-described take-over data socket and routing technique, the post-time SASE 210 as the second network analyzer software can be transformed into a real-time second network analyzer software, such as the SART 212.

Advantageously, the take-over data socket technique described herein minimizes investment and takes a time-to-market approach to provide new measurements, by requiring only slight modification to a network data capturing system, including its associated first network analyzer software, to interface in a real-time fashion the network data capturing equipment with a second network analyzer software.

The above-described embodiments can be implemented in software and/or computing hardware. Therefore, embodiments described herein allow incorporating two different software systems together without software transplanting. The embodiment(s) described herein provide interfacing a network data analyzer software with a real-time network data acquisition system without porting, rewriting and/or writing an interface with the real-time network data acquisition system (i.e., preservingly, maintainably, or transparently interfacing a first network data analyzer software with a second incompatible network data analyzer software). Further, the embodiment(s) described herein provide(s) enabling a single network data analyzer software application to analyze (i.e., provide measurements relating to) network data captured concurrently in real-time from two or more real-time network data acquisition systems. More particularly, the embodiment(s) described herein provide a method and computer system thereof, comprising enabling real-time network protocol analysis of network data by a post-time network protocol analyzing software that is incompatible with a real-time protocol analyzing software/system real-time capturing the network data, by controlling the real-time protocol analyzing software/system and a communication socket opened by the real-time protocol analyzing software/system to the real-time network data, thereby transparently porting the post-time network protocol analyzing software to the real-time protocol analyzing software. Further, a method and system of enabling the post-time network data analyzer software to analyze network data captured concurrently in real-time from two or more of the real-time protocol analyzing software/systems based upon time stamping by the real-time protocol analyzing software/systems of every data frame received over a plurality of the taken-over sockets.

The many features and advantages of the above-described embodiments are apparent from the detailed specification and, thus, it is intended by the appended claims to cover all such features and advantages of the embodiments that fall within the true spirit and scope of the embodiments. Further, since numerous modifications and changes will readily occur to those skilled in the art, it is not desired to limit the described embodiments to the exact construction and operation illustrated and described, and accordingly all suitable modifications and equivalents may be resorted to, falling within the scope of the embodiments defined in the claims and their equivalents.

1. A method, comprising:
real-time capturing network data via a first opened data socket between a first network analysis application and a real-time acquisition system;
taking over the first opened data socket by opening a second data socket between a second network analysis application and the real-time acquisition system, via a direct take-over socket request command from the second network analysis application to the real-time acquisition system;
controlling the real-time acquisition system by the second network analysis application, according to control commands from the second network analysis application via the first network analysis application; and
providing real-time network data measurements by the second network analysis application based upon the controlling of the real-time acquisition system via the first network analysis application and real-time captured network data from the opened second data socket.

2. The method of claim 1, wherein the first network analysis application controls the real-time acquisition system according to a first non-standard interface, and the controlling of the real-time acquisition system by the second network analysis application via the first network analysis application comprises:
defining a second interface between the first and second network analysis applications according to a standard interface specification at a higher level of abstraction in relation to the first non-standard interface between the first signaling analyzer application and the real-time acquisition system.

3. The method of claim 2, wherein the defining of the second interface according to the standard interface specification between the first and second network analysis applications comprises defining an extensible markup language (XML) based interface to encapsulate abstracted control related messages of the first non-standard interface to control the real-time acquisition system via the first network analysis application.

4. The method of claim 1, wherein the first network analysis application controls the real-time acquisition system according to a first interface, and the controlling of the real-time acquisition system by the second network analysis application via the first network analysis application comprises:
defining a second interface between the first and second network analysis applications based upon extensible markup language (XML) messages at a higher level of abstraction in relation to the first interface between the first network analysis application and the real-time acquisition system;
generating a control message based upon the defined XML messages of the second interface;
transmitting the generated XML message to the first network analysis application;
translating by the first network analysis application the generated XML message into a message according to the first interface to control the real-time acquisition system; and
transmitting by the first network analysis application the translated first interface message to the real-time acquisition system to control the real-time acquisition system concerning the real-time network data captured by the real-time acquisition system.

5. The method of claim 1, wherein the taking over the first opened data socket comprises:
in response to the direct take-over socket request from the second network analysis application, closing by the real-time acquisition system the first opened data socket between the first network analysis application and the real-time acquisition system; and
opening by the real-time acquisition system the second data socket between the second network analysis application and the real-time acquisition system.

6. The method of claim 1,
wherein the real-time capturing the network data comprises:
real-time capturing network data via a plurality of first opened data sockets between a plurality of corresponding first network analysis applications and real-time acquisition systems, and
time stamping every data frame captured by each real-time acquisition system,
wherein the taking over the first opened data socket comprises:
taking over the plurality of the first opened data sockets by opening a plurality of second data sockets between the second network analysis application and the real-time acquisition systems, via direct take-over socket request commands from the second network analysis application to the real-time acquisition systems, and
rearranging by the second network analysis application the data frames received from each real-time acquisition system via the second data sockets in time order according to the time stamping of the data frames, and
wherein the providing of the real-time network data measurements comprises concurrently analyzing the real-time captured network data by two or more of the real-time acquisition systems.

7. The method of claim 1, wherein the real-time capturing the network data comprising capturing real-time network data from one or more network types of a dedicated phone connection, mobile communication, fiber-optic transmission system, and packet or cell network technology.

8. The method of claim 7, wherein the dedicate phone connection is one or more of TI/DS1/E1 and T3/DS3/E3, the mobile communication is 3G wireless mobile communications, the fiber-optic transmission system is Synchronous Optical Network (SONET), and the packet or cell network technology is Asynchronous Transfer Mode (ATM).

9. A method, comprising:
time stamping every data frame captured by multiple network data capturing equipments; and
rearranging in a network analysis software the data frames received from the multiple network data capturing systems, via data sockets to the multiple data capturing equipments, in time order by comparing the time stamps of each received data frame, thereby enabling one network analysis software to concurrently receive and analyze network data captured by the multiple data capturing equipments.

10. A network data analyzer communicably connectable with an incompatible real-time network data acquisition system, the network data analyzer comprising:
a programmed computer processor controlling the network data analyzer according to a process comprising:
launching the incompatible real-time acquisition system;
taking over, via a direct take-over socket request command to the incompatible real-time acquisition system, a data socket opened by the incompatible real-time acquisition system in response to the launching to real-time capture network data;
controlling the incompatible real-time acquisition system according to control commands translatable by the incompatible real-time acquisition system; and
providing real-time network data measurements based upon the real-time captured network data, via the taken-over communication socket, and based upon the controlling of the incompatible real-time acquisition system via the translatable control commands.

11. The network data analyzer of claim 10, wherein the control commands translatable by the incompatible real-time network data acquisition system to real-time capture the network data comprise a standard interface specification at a higher level of abstraction in relation to a non-standard interface between an incompatible network analysis application and a real-time network data capturing equipment of the incompatible real-time network data acquisition system.

12. The network analyzer of claim 11, wherein the standard interface specification at the higher level abstraction is an extensible markup language (XML) based interface to encapsulate abstracted control related messages of the non-standard interface used between the incompatible network analysis application and the real-time network data capturing equipment of the incompatible real-time network acquisition system.

13. The network analyzer of claim 10, wherein the network analyzer is communicably connectable with a plurality of the incompatible real-time network data acquisition systems, each real-time capturing network data and time stamping every real-time captured data frame,
wherein the process by the programmed computer processor further comprises:
launching the plurality of the incompatible real-time network data acquisition systems;
taking over, via direct take-over socket request commands to the incompatible real-time network data acquisition systems, data sockets opened by the incompatible real-time network data acquisition systems in response to the launchings to real-time capture network data;
controlling each incompatible real-time network data acquisition system according to control commands translatable by each incompatible real-time network data acquisition system; and
rearranging the data frames received from each real-time network acquisition system via the taken-over sockets in time order according to the time stamping of the data frames, and
wherein the providing of the real-time network data measurements comprises concurrently analyzing the real-time captured network data by two or more of the real-time network data acquisition systems.

14. The network analyzer of claim 10, wherein the incompatible network data acquisition system real-time captures the network data from one or more network types of a dedicated phone connection, mobile communication, fiber-optic transmission system, and packet or cell network technology.

15. The method of claim 14, wherein the dedicate phone connection is one or more of TI/DS1/E1 and T3/DS3/E3, the mobile communication is 3G wireless mobile communications, the fiber-optic transmission system is Synchronous Optical Network (SONET), and the packet or cell network technology is Asynchronous Transfer Mode (ATM).

16. A data network test computer system, comprising:
network data acquisition means for real-time capturing network data via a first opened data socket;
network data analyzer means incompatible with the network data acquisition means and for taking over the first opened data socket, via a direct take-over socket request command to the network data acquisition means, to provide real-time network data measurements based upon controlling the network data acquisition means and the real-time captured network data from the taken-over data socket.

17. A real-time multi-port network data analysis device, comprising:
a programmed computer processor controlling the analysis device according to a process comprising:
collecting data frames real-time captured and time stamped by multiple network data capturing equipments at multiple network access points;
centrally time synchronizing the data frames according to the time stamps of the data frames; and
centrally presenting a real-time multi-port measurement based upon the time synchronizing of the data frames.
